(19) United States
(12) Patent Application Publication
(10) Pub. No.: US 2015/0198230 A1
(43) Pub. Date: Jul. 16, 2015

(54) CAM FOLLOWER ASSEMBLY HAVING SWAGED BUSHING

(71) Applicant: Electro-Motive Diesel Inc., LaGrange, IL (US)

(72) Inventors: Timothy J. PAULSON, Schererville, IN (US); Stephen M. Bednarz, De Kalb, IL (US)

(73) Assignee: Electro-Motive Diesel Inc., LaGrange, IL (US)

(21) Appl. No.: 14/153,378

(22) Filed: Jan. 13, 2014

(51) Int. Cl. F16H 53/06; F16B 4/00

(52) U.S. Cl. CPC F16H 53/06; F16B 4/004

(57) ABSTRACT

A cam follower assembly is disclosed. The cam follower assembly may include a forked body having a main bore, and a cam roller disposed within the main bore. The cam roller may include a hollow and generally cylindrical body having an outer surface configured to engage a camshaft. The cam follower assembly may also include a bushing having a generally cylindrical body having an outer surface configured to be press-fitted with the cam roller, a central bore formed within the generally cylindrical body of the bushing, and at least one swaged end configured to inhibit axial movement of the bushing. The cam follower assembly may further include an inner race disposed within the central bore of the bushing and configured to rotatably support the bushing.

### TECHNICAL FIELD

The present disclosure relates generally to a cam follower assembly, and more particularly, to a cam follower assembly having a swaged bushing.

### BACKGROUND

Fuel injectors in an internal combustion engine are typically driven by a cam arrangement that is operably connected to a crankshaft of the engine. Rotation of the crankshaft results in a corresponding rotation of a cam that drives one or more cam followers. The movement of the cam followers results in actuation of the fuel injectors. The shape of the cam governs the timing and duration of the fuel injection. Each cam follower may include, among other things, a roller in contact with the cam, and a bushing that rotatably supports the roller.

An exemplary cam follower is disclosed in U.S. Pat. No. 7,703,984 that issued to Watanabe et al. on Apr. 27, 2010 (“the '984 patent”). Specifically, the '984 patent discloses a rocker arm operably connected to a valve on a first end and operably connected to a cam on a second end. At the second end, the rocker arm includes a cam follower having a bifurcated roller holder, a roller in contact with the cam, and rolling elements that rotatably support the roller along a roller shaft. Both ends of the roller shaft are swage-locked to beveled sides of the roller holder, such that the roller shaft is secured to the roller holder.

Although the cam follower of the '984 patent may be suitable for some applications, it may still be less than optimal. For example, because swage-locking the roller shaft causes deformation, excessive wear can result and replacement of the roller shaft may be needed. This replacement can be expensive in some situations. Also, the swage-locked ends of the roller shaft may not completely prevent axial movement of the rolling elements and/or the roller. Axial movement of the rolling elements and/or the roller can cause the roller to lock against the roller holder, thereby causing premature wear and/or failure of the roller.

The cam follower assembly of the present disclosure is directed towards overcoming one or more of the problems set forth above and/or other problems of the prior art.

### SUMMARY OF THE DISCLOSURE

One aspect of the present disclosure is directed to a bushing for a cam follower assembly having a cam roller and an inner race. The bushing may include a generally cylindrical body having an outer surface configured to be press-fitted with the cam roller. The bushing may also include a central bore formed within the generally cylindrical body and configured to receive the inner race. The bushing may further include at least one swaged end configured to inhibit axial movement of the bushing.

Another aspect of the present disclosure is directed to a cam follower assembly. The cam follower assembly may include a forked body having a main bore, and a cam roller disposed within the main bore. The cam roller may include a hollow and generally cylindrical body having an outer surface configured to engage a camshaft. The cam follower assembly may also include a bushing having a generally cylindrical body having an outer surface configured to be press-fitted with the cam roller, a central bore formed within the generally cylindrical body of the bushing, and at least one swaged end configured to inhibit axial movement of the bushing. The cam follower assembly may further include an inner race disposed within the central bore of the bushing and configured to rotatably support the bushing.

In yet another aspect, the present disclosure is directed to a method of forming a bushing having a generally cylindrical body, a central bore formed within the generally cylindrical body, and two opposing ends. The method may include press-fitting the bushing into a cam roller. The method may also include swaging at least one of the two opposing ends to inhibit axial movement of the bushing and secure the bushing to the cam roller.

### BRIEF DESCRIPTION OF THE DRAWINGS

FIG. 1 is a diagrammatic illustration of an exemplary disclosed engine;

FIG. 2 is a cross-sectional view illustration of an exemplary disclosed cam follower assembly that may be used in conjunction with the engine of FIG. 1;

FIG. 3 is a cross-sectional view illustration taken along line 3-3 of the cam follower assembly of FIG. 2; and

FIGS. 4 and 5 are cross-sectional view illustrations of an exemplary disclosed bushing that may be used in conjunction with the cam follower assembly of FIG. 3, and an exemplary disclosed tooling that may be used to swage the bushing.

### DETAILED DESCRIPTION

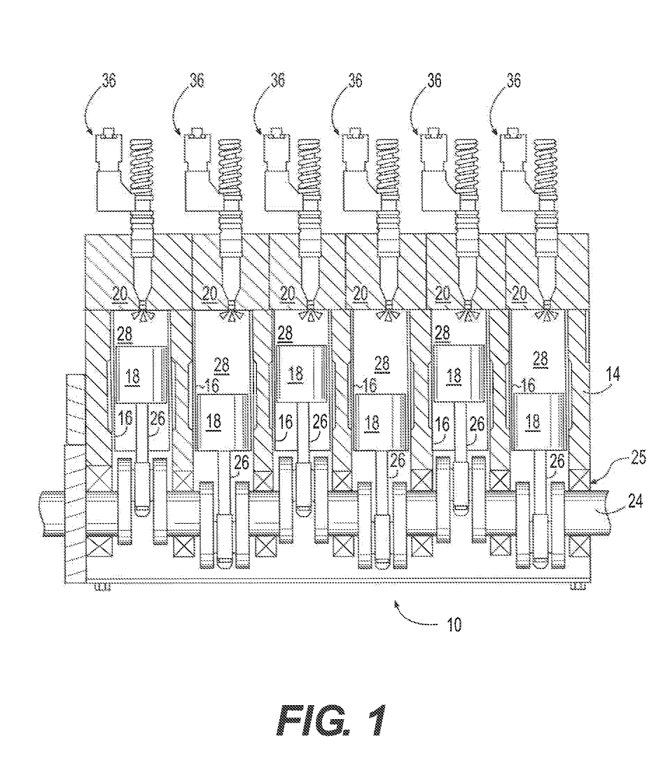

FIG. 1 illustrates an exemplary engine 10. For the purposes of this disclosure, engine 10 is depicted and described as a two-stroke diesel engine. One skilled in the art will recognize, however, that engine 10 may be any other type of internal combustion engine such as, for example, a two- or four-stroke gasoline or gaseous fuel-powered engine.

Engine 10 may include an engine block 14 that at least partially defines a plurality of cylinders 16. A piston 18 may be slidably disposed within each cylinder 16 to reciprocate between a top-dead-center position and a bottom-dead-center position, and a cylinder head 20 may be associated with each cylinder 16. Each cylinder 16, piston 18, and cylinder head 20 may together at least partially define a combustion chamber 28. A fuel injector assembly 36 may be at least partially disposed within each cylinder head 20 and configured to inject fuel into each respective combustion chamber 28 to support fuel combustion within engine 10. Engine 10 may also include a crankshaft 24 that is rotatably supported within engine block 14 by way of a plurality of journal bearings 25. A connecting rod 26 may connect each piston 18 to crankshaft 24 so that a sliding motion of piston 18 within each respective cylinder 16 results in a rotation of crankshaft 24.

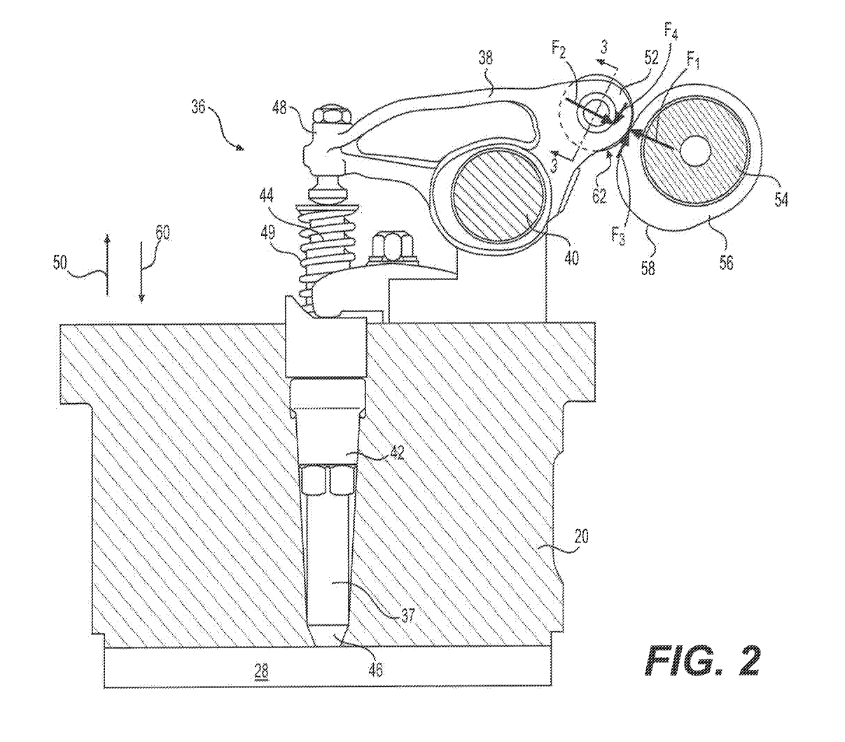

As shown in FIG. 2, fuel injector assembly 36 may be configured to inject or otherwise spray fuel, for example, diesel fuel, directly into each combustion chamber 28 via a fuel port 37 within cylinder head 20 in accordance with a desired timing. Fuel injector assembly 36 may embody a mechanically-actuated, electronically-controlled unit injector that is in fluid communication with a common fuel rail (not shown). Alternatively, fuel injector assembly 36 may be any common rail type injector and may be actuated and/or operated hydraulically, mechanically, electrically, piezo-electrically, or any combination thereof. The common fuel rail may provide fuel to fuel injector assembly 36 associated with each combustion chamber 28.

Fuel injector assembly 36 may be driven by a rocker arm 38 that is pivotally coupled to a rocker shaft 40. Each fuel injector assembly 36 may include an injector body 42, a plunger 44, and an injector tip 46. A first end 48 of rocker arm 38 may be operatively coupled to plunger 44. Plunger 44 may be biased by a spring 49 toward the first end 48 of rocker arm 38 in the general direction of an arrow 50.

A second end 52 of rocker arm 38 may be operatively coupled to a camshaft 54. More specifically, a cam follower assembly 62 may be disposed in operative connection between camshaft 54 and injector rocker arm 38. Camshaft 54 may include a cam 56 having an outer profile that determines, at least in part, the fuel injection timing of fuel injector assembly 36 during operation of engine 10. In one embodiment, cam 56 may have at least one lobe 58. Camshaft 54 may be operably connected to crankshaft 24 (shown only in FIG. 1), for example, directly, by way of a gear train, and/or with a variable timing device. In this manner, crankshaft 24 may drive camshaft 54 to rotate at a corresponding speed. Lobe 58 may be moved into and out of contact with cam follower assembly 62 during rotation of camshaft 54 to provide injections of fuel at predetermined crank angles.

When lobe 58 is rotated into contact with cam follower assembly 62, lobe 58 may exert a force F₁ on cam follower assembly 62. In response, the second end 52 of rocker arm 38 may be urged in the general direction of arrow 50. As the second end 52 is urged in the general direction of arrow 50, rocker arm 38 may pivot about rocker shaft 40, thereby causing the first end 48 to be urged in the general direction of an arrow 60. The force F₁ exerted on cam follower assembly 62 by lobe 58 may be greater in magnitude than a bias force F₂ generated by spring 49, thereby causing plunger 44 to be likewise urged in the general direction of arrow 60. When camshaft 54 is rotated beyond a peak of lobe 58, the bias of spring 49 may urge plunger 44 in the general direction of arrow 50. As plunger 44 is urged in the general direction of arrow 50, the first end 48 of rocker arm 38 may likewise be urged in the general direction of arrow 50 to cause rocker arm 38 to pivot about rocker shaft 40. When this happens, the second end 52 may be urged in the general direction of arrow 60.

During operation of engine 10, axial forces may be generated between one or more components of cam follower assembly 62. For example, in one embodiment, a first force F₃ and/or a second force F₄ may be generated and urge the components of cam follower assembly 62 in opposite directions (e.g., into and out of page shown in FIG. 2). If unaccounted for, these forces F₃, F₄ may cause one or more components of cam follower assembly 62 to axially misalign, thereby causing premature wear, deformation, and/or failure of the components.

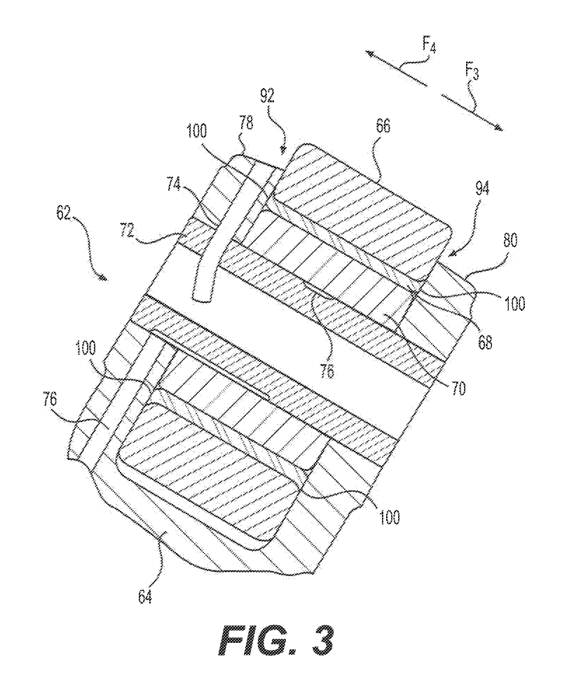

As shown in FIG. 3, cam follower assembly 62 may include a forked body 64, a cam roller 66, a bushing 68, an inner race 70, and an axle 72. In the disclosed embodiment, forked body 64 has first and second tines 78, 80 defining a main bore. Axle 72 may be fixedly mounted to tines 78, 80 of forked body 64 via a pin 74. Pin 74 may be pressed through aligned bores in forked body 64 and axle 72 to lock axle 72 to forked body 64. Cam roller 66, bushing 68, and inner race 70 may all be rotatably mounted within the main bore between tines 78, 80. Inner race 70 may be rotatably mounted on axle 72. Bushing 68 may be press-fitted with cam roller 66, and together, cam roller 66 and bushing 68 may be slip-fitted onto inner race 70. Additionally, one or more lubrication holes 76 may be formed within body 64 and extend to annular recesses between inner race 70 and axle 72, such that lubricant can be distributed to each of the components of cam follower assembly 62.

Cam roller 66 may embody a hollow and generally cylindrical body having an outer surface configured to engage cam lobe 58 of camshaft 54, such that cam roller 66 rotates with a corresponding rotation of camshaft 54. Bushing 68 may also embody a hollow and generally cylindrical body having an outer surface configured to be press-fitted with an inner surface of cam roller 66. Bushing 68 may rotatably support cam roller 66. Bushing 68 may include a central bore configured to receive inner race 70. Inner race 70 may embody a hollow and generally cylindrical body having an outer surface configured to be slip-fitted with an inner surface of bushing 68. Inner race 70 may rotatably support bushing 68. Axle 72 may be a hollowed shaft configured to rotatably support inner race 70.

In some embodiments, cam roller 66 may be made of a hardened steel alloy with a hardness that substantially matches a hardness of camshaft 54. Bushing 68 may be made of a non-hardened mild steel backing ring with cast bronze material and a lead-tin outer coating. The outer coating may have a hardness substantially greater than a hardness of the cast bronze inner surface. Inner race 70 may be made of a hardened steel to provide a hard bearing outer journal surface to rotate against the soft inner bearing surface of bushing 68.

As discussed above, during operation of engine 10, forces F₃, F₄ may tend to urge components of cam follower assembly 62 to move axially (e.g., cam roller 66 and/or bushing 68). In some situations, these forces F₃, F₄ may gradually reduce a retention force of the press-fit connection between cam roller 66 and bushing 68. That is, the forces F₃, F₄ may loosen the connection between cam roller 66 and bushing 68, causing bushing 68 to move in an axial direction (indicated by arrows shown in FIG. 3) towards one of tines 78, 80 of forked body 64. This movement of bushing 68 may then cause cam roller 66 to move in an opposite axial direction towards an opposing one of tines 78, 80, which can cause cam roller 66 to come into contact with the respective tine 78, 80. When roller 66 contacts the respective tine 78, 80, this may cause roller 66 to lock up (i.e., not rotate) and/or to heat up from frictional contact with lobe 58, thereby causing deformation and/or premature failure of cam roller 66. In some applications, this may also cause deformation and/or premature failure of camshaft 54 because of the misalignment of cam roller 66.

In order to inhibit movement of bushing 68, bushing 68 may be swaged or peened on at least one of opposing ends 92, 94. For example, bushing 68 may include at least one swaged end 100 that helps secure the axial connection between cam roller 66 and bushing 68. Specifically, swaged ends 100 may include an outwardly deformed protrusion in a radial direction. In the disclosed embodiment, both ends 92, 94 of bushing 68 are swaged. The swaged ends 100 of bushing 68 may inhibit movement of bushing 68 in an axial direction towards either tine 78, 80 of forked body 64. As a result, this may help to prevent roller 66 from contacting tines 78, 80 and causing lock up of cam roller 66.

In some embodiments, ends 92, 94 of bushing 68 may include generally flat, annular surfaces. Swaged ends 100 may be formed on either end 92, 94 by swaging around an entire periphery of the annular surfaces. In other words, swaging may occur at each point around the periphery (e.g., 360° around the annular surface). It is contemplated that, in other embodiments, swaged ends 100 may be formed by mechanically swaging or thermal-mechanically swaging only a discrete number of locations around the annular surface, for example, four equally distanced locations.

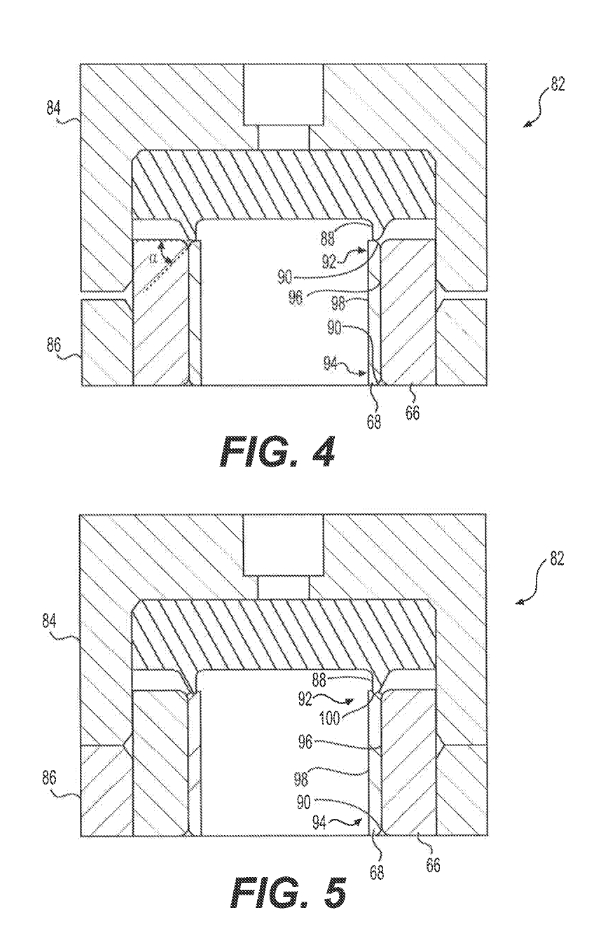

FIGS. 4 and 5 illustrate cross-sectional views of bushing 68 during a swaging process. As shown in FIGS. 4 and 5, a swaging tool 82 may be used to swage one or more ends 92, 94 of bushing 68. Swaging tool 82 may embody any type of hydraulic tooling, mechanical tooling, or any other swaging tool known in the art. Swaging tool 82 may include an annular punch holder 84 and an annular die 86. The annular shapes of punch holder 84 and die 86 in combination with close tolerances between inside diameters of punch holder 84 and die 86 and an outer diameter of roller 66 may secure and center roller 66 and bushing 68 during the swaging process. Punch holder 84 may be actuated by any actuation means known to the art (e.g., hydraulic press). Punch holder 84 may include an annular punch feature 88 that is configured to swage ends 92, 94 of bushing 68. More specifically, annular punch feature 88 may have a sharp, annular edge that is configured to deform an outer diameter 90 of ends 92, 94 of bushing 68. As shown in FIG. 5, during actuation, horizontal surfaces of punch holder 84 and die 86, which are initially separated by a gap, may be pressed together and contact each other at a completion of the swaging process. This contact between punch holder 84 and die 86 limits an amount of deformation during the swaging and provides a means of absorbing excess die force, thereby preventing damage to roller 66 and/or bushing 68. It is contemplated that, in some embodiments, swaging tool 82 may include two punch holders 84 and two punch features 88 positioned above and below bushing 68, such that both ends 92, 94 of bushing 68 can be swaged at substantially the same time.

As shown in FIG. 4, before the swaging process, bushing 68 may have a machined chamfered edge 90 at outer diameter 96 on both ends 92, 94 of bushing 68. In one embodiment, chamfered edge 90 may have an angle α of about 45° with respect to a longitudinal axis of bushing 68. Chamfered edge 90 may provide clearance to help press-fit bushing 68 with cam roller 66. In the disclosed embodiment, bushing 68 is press-fitted with cam roller 66 prior to the swaging process.

As shown in FIG. 5, during the swaging process, when punch feature 88 mounted inside punch holder 84 contacts chamfered edge 90 of bushing 68, material from an outer diameter 96 of bushing 68 may be pushed outward towards an inner diameter of cam roller 66. This process may form swaged end 100, which inhibits axial movement of bushing 68 in the axial direction, thereby securing bushing 68 to cam roller 66. In the disclosed embodiment, punch feature 88 is shaped, such that only outer diameter 96 of bushing 68 is swaged. For example, punch feature 88 may include an axially aligned edge that contacts an inner portion of bushing 68 and a curved edge that contacts an outer portion of bushing 68. The shape of punch feature 88 may allow an inner diameter 98 of bushing 68 may remain substantially unchanged, in order to maintain structural integrity of bushing 68.

### INDUSTRIAL APPLICABILITY

The disclosed cam follower assembly 62 may be used with any internal combustion engine. The cam follower assembly 62 may include bushing 68 having at least one swaged end 100 to inhibit undesired axial movement of bushing 68 and cam roller 66. By inhibiting movement of these components, wearing of cam roller 66 and/or camshaft 54 may be reduced.

In addition, only an outer diameter 96 of bushing 68 may be swaged to maintain structural integrity of an inner diameter 98 of bushing 68. Also, in some applications, bushing 68 may include two swaged ends 100 to further increase retention of bushing 68 within cam roller 66. In other applications, swaged ends 100 may be formed by swaging an entire annular surface associated with the swaged end 100, resulting in a stronger connection between cam roller 66 and bushing 68.

It will be apparent to those skilled in the art that various modifications and variations can be made to the disclosed cam follower assembly. Other embodiments will be apparent to those skilled in the art from consideration of the specification and practice of the disclosed system. It is intended that the specification and examples be considered as exemplary only, with a true scope being indicated by the following claims and their equivalents.

What is claimed is:

1. A bushing for a cam follower assembly having a cam roller and an inner race, comprising:
a generally cylindrical body having an outer surface configured to be press-fitted with the cam roller;
a central bore formed within the generally cylindrical body and configured to receive the inner race; and
at least one swaged end configured to inhibit axial movement of the bushing.

2. The bushing of claim 1, wherein the at least one swaged end includes two opposing swaged ends.

3. The bushing of claim 1, wherein the at least one swaged end includes an outwardly deformed protrusion around an entire periphery of the bushing.

4. The bushing of claim 1, wherein the at least one swaged end includes a deformed outer diameter and a substantially unchanged inner diameter.

5. The bushing of claim 1, wherein the bushing is made of a non-hardened mild steel backing ring with cast bronze material and a lead-tin outer coating.

6. The bushing of claim 1, wherein the at least one swaged end is formed by swaging a 45° chamfered edge located on an outer diameter of the bushing.

7. The bushing of claim 1, wherein the bushing is press-fitted with the cam roller prior to swaging the at least one swaged end.

8. A cam follower assembly, comprising:
a forked body having a main bore;
a cam roller disposed within the main bore, the cam roller including a hollow and generally cylindrical body having an outer surface configured to engage a camshaft;
a bushing including:
a generally cylindrical body having an outer surface configured to be press-fitted with the cam roller;
a central bore formed within the generally cylindrical body of the bushing; and
at least one swaged end configured to inhibit axial movement of the bushing; and
an inner race disposed within the central bore of the bushing and configured to rotatably support the bushing.

9. The cam follower assembly of claim 8, wherein the at least one swaged end includes two opposing swaged ends.

10. The cam follower assembly of claim 8, wherein the at least one swaged end includes an outwardly deformed protrusion around an entire periphery of the bushing.

11. The cam follower assembly of claim 8, wherein the at least one swaged end includes a deformed outer diameter and a substantially unchanged inner diameter.

12. The cam follower assembly of claim 8, wherein the bushing is made of a non-hardened mild steel backing ring with cast bronze material and a lead-tin outer coating.

13. The cam follower assembly of claim 8, wherein the at least one swaged end is formed by swaging a 45° chamfered edge located on an outer diameter of the bushing.

14. The cam follower assembly of claim 8, wherein the bushing is press-fitted with the cam roller prior to swaging the at least one swaged end.

15. A method of forming a bushing having a generally cylindrical body, a central bore formed within the generally cylindrical body, and two opposing ends, the method comprising:
press-fitting the bushing into a cam roller; and
swaging at least one of the two opposing ends to inhibit axial movement of the bushing and secure the bushing to the cam roller.

16. The method of claim 15, wherein swaging at least one of the two opposing ends includes swaging both of the opposing ends.

17. The method of claim 15, wherein swaging at least one of the two opposing ends includes swaging only an outer diameter of the bushing, and leaving an inner diameter of the bushing substantially unchanged.

18. The method of claim 15, wherein swaging at least one of the two opposing ends includes swaging an entire periphery of the at least one of the two opposing ends.

19. The method of claim 15, wherein swaging at least one of the two opposing ends includes swaging a 45° chamfered edge located at each of the at least one of the two opposing ends.

20. The method of claim 15, wherein press-fitting the bushing into the cam roller occurs prior swaging the at least one of the two opposing ends.

21. The method of claim 15, swaging at least one of the two opposing ends includes mechanically swaging or thermal-mechanically swaging at a discrete number of locations around an annular surface of the bushing.
